(19) United States
(12) Patent Application Publication
(10) Pub. No.: US 2015/0178271 A1
(43) Pub. Date: Jun. 25, 2015

(54) AUTOMATIC CREATION OF A SEMANTIC DESCRIPTION OF A TARGET LANGUAGE

(71) Applicant: ABBYY InfoPoisk LLC, Moscow (RU)

(72) Inventor: Vladimir Pavlovich Selegey, Moscow (RU)

(21) Appl. No.: 14/509,412

(22) Filed: Oct. 8, 2014

(30) Foreign Application Priority Data
Dec. 19, 2013 (RU) 2013156492

(51) Int. Cl. G06F 17/27

(52) U.S. Cl. CPC G06F 17/2785; G06F 17/2705

(57) ABSTRACT

Disclosed are methods, systems, and computer-readable mediums for creating a semantic description of a target language having full language descriptions of a source language. Parallel text of a source language and a target language is aligned such that text in the source language is correlated to text in the target language. The text in the source language is parsed to construct a syntactic structure, comprising a lexical element, and a semantic structure, of the source language. A hypothesis is generated about a lexical element of the target language that corresponds to the lexical element of the source language. The lexical element of the target language is compared, based on the hypothesis, to the corresponding lexical element of the source language. A syntactic model for the lexical element of the target language is associated with a syntactic model for the lexical element of the source language.

### CROSS REFERENCE TO RELATED APPLICATIONS

This application also claims the benefit of priority under 35 USC 119 to Russian Patent Application No. 2013156492, filed Dec. 19, 2013; the disclosures of priority applications are incorporated herein by reference.

### BACKGROUND

A majority of Natural Language Processing (NLP) systems are based on the use of statistical methods, where minimal language descriptions are created manually. This approach is inexpensive and fast because the emergence of a large volume of text corpora in recent years and the growth in computing power makes it possible to quickly extract the necessary statistical information from the language for machine training. This approach is also popular because it is sufficient to solve some ordinary problems. However, this approach does not ensure the construction of a full model of the corpora that covers all aspects of the language of the corpora (i.e., morphology, lexicon, syntax, and lexical semantics).

The task of creating such a full model, which can be used to solve the most diverse language-processing tasks and to create stable and reliable technologies, still requires a large amount of manual work to be done by qualified linguists.

An example of a thesaurus-type semantic dictionary is WordNet. The WordNet dictionary consists of four networks corresponding to the basic parts of speech: nouns, verbs, adjectives, and adverbs. The base dictionary units in WordNet are sets of cognitive synonyms (“synsets”) that are interlinked by means of conceptual-semantic and lexical relations. The synsets are nodes in the WordNet networks, and each synset contains definitions and examples of the use of words in context. Words that have several lexical meanings are included in several synsets and may be included in differing syntactic and lexical classes.

### SUMMARY

Disclosed are methods, systems, and computer-readable mediums for creating a semantic description (thesaurus-type dictionary) of a target language based on a semantic hierarchy for the source language and a set of parallel texts, particularly where the source language and target language are related (i.e. kindred).

One embodiment relates to a method, which comprises aligning parallel text of a source language and a target language such that text in the source language is correlated to text in the target language. The method further comprises parsing the text in the source language to construct a syntactic structure, comprising a lexical element, and a semantic structure of each sentence of the text of the source language. The semantic structure comprises a language-independent representation of the sentence in the source language. The method further comprises using a translation dictionary to generate a hypothesis about a lexical element of the target language that corresponds to the lexical element of the source language. The method further comprises comparing the lexical element of the target language to the corresponding lexical element of the source language, where the comparison is based on the hypothesis. The method further comprises associating, based on the comparison, a syntactic model for the lexical element of the target language with a syntactic model for the lexical element of the source language.

Another embodiment relates to a system comprising a processing device. The processing device is configured to align parallel text of a source language and a target language such that text in the source language is correlated to text in the target language. The processing device is further configured to parse the text in the source language to construct a syntactic structure and a semantic structure of a sentence in the source language, wherein the syntactic structure comprises a lexical element of the source language, and wherein the semantic structure comprises a language-independent representation of the sentence in the source language. The processing device is further configured to generate, based on a translation dictionary, a hypothesis about a lexical element of the target language that corresponds to the lexical element of the source language. The processing device is further configured to compare the lexical element of the target language to the corresponding lexical element of the source language, wherein the comparison is based on the hypothesis. The processing device is further configured to associate, based on the comparison, a syntactic model for the lexical element of the target language with a syntactic model for the lexical element of the source language.

Another embodiment relates to a non-transitory computer-readable medium having instructions stored thereon, the instructions comprise instructions to align parallel text of a source language and a target language such that text in the source language is correlated to text in the target language. The instructions further comprise instructions to parse the text in the source language to construct a syntactic structure and a semantic structure of a sentence in the source language, wherein the syntactic structure comprises a lexical element of the source language, and wherein the semantic structure comprises a language-independent representation of the sentence in the source language. The instructions further comprise instructions to generate, based on a translation dictionary, a hypothesis about a lexical element of the target language that corresponds to the lexical element of the source language. The instructions further comprise instructions to compare the lexical element of the target language to the corresponding lexical element of the source language, wherein the comparison is based on the hypothesis. The instructions further comprise instructions to associate, based on the comparison, a syntactic model for the lexical element of the target language with a syntactic model for the lexical element of the source language.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are, therefore, not to be considered limiting of its scope, the disclosure will be described with additional specificity and detail through use of the accompanying drawings.

FIG. 1 shows a flow diagram of operations for automatic creation of a semantic description of a target language in accordance with one embodiment.

FIG. 2 is a chart illustrating language descriptions in accordance with one embodiment.

FIG. 3 is a chart illustrating morphological descriptions in accordance with one embodiment.

FIG. 4 is a chart illustrating syntactic descriptions in accordance with one embodiment.

FIG. 5 is a chart illustrating semantic descriptions in accordance with one embodiment.

FIG. 6 is a chart illustrating lexical descriptions in accordance with one embodiment.

FIG. 7 shows stages of an analysis method in accordance with one embodiment.

FIG. 7A shows a sequence of data structures built from the process of analyzing in accordance with one embodiment.

FIGS. 8 and 8A show two different syntactic trees for the English sentence “The girl in the sitting-room was playing the piano.”

FIG. 9 shows a semantic structure for the English sentence “The girl in the sitting-room was playing the piano.”

FIG. 10 shows a semantic structure for the Russian sentence “ [symbol] [symbol] [symbol] [symbol] ,” which corresponds to the English sentence “The girl in the sitting-room was playing the piano.”

FIG. 11 depicts an effect of a stage of construction of the semantic description of a target language based on parsing the Russian sentence “ [symbol] [symbol] [symbol] [symbol] ” and its Polish equivalent, “Dziewczyna w salonie gry na pianinie,” in accordance with one embodiment.

FIG. 12 shows a syntactic structure for the Russian sentence “ [symbol] [symbol] [symbol] [symbol] .”

FIG. 13 shows hardware that may be used to implement the techniques described herein.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

The methods, computer-readable mediums, and systems described herein serve to automate a large amount of manual work by linguists to create syntactic-semantic descriptions of language being added to the system. In particular, according to the disclosed techniques, the most labor-intensive part of describing the lexical syntax may be automated.

Using a well-described source language that includes all the necessary linguistic (e.g., syntactic and semantic) descriptions, a set of aligned parallel texts along with a translation dictionary may then be used to create analogous descriptions for a related language (such as for Ukrainian based on Russian).

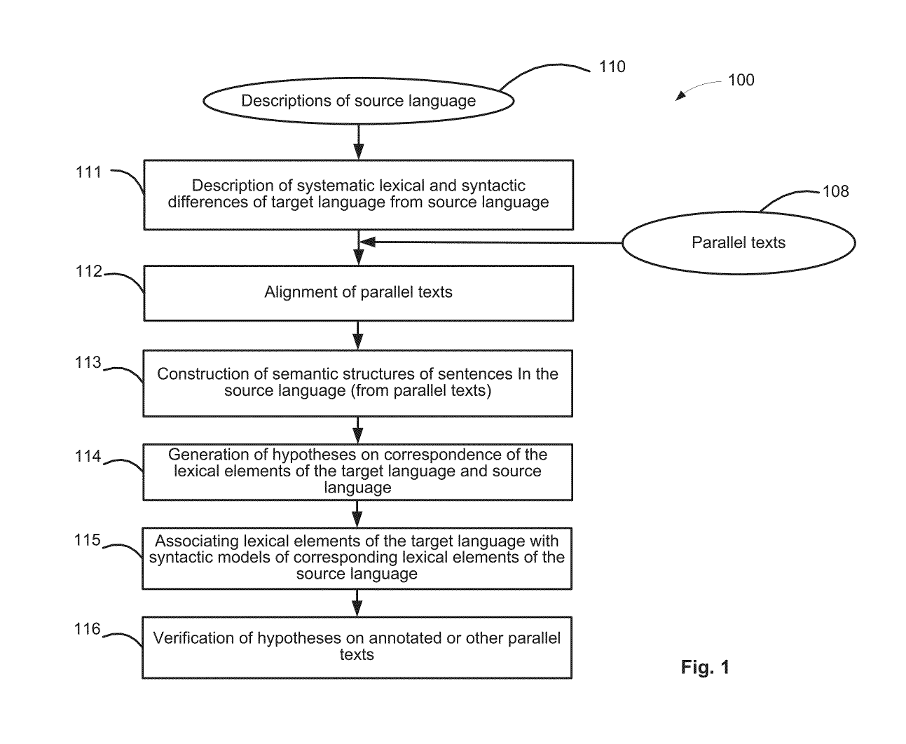

The necessary linguistic descriptions may include lexical descriptions, morphological descriptions, syntactic descriptions, and semantic descriptions. Referring to FIG. 1, a flow diagram of stages for a process (100) for the automatic creation of a semantic description of a target language is shown according to one embodiment. In alternative embodiments, fewer, additional, and/or different actions may be performed. Also, the use of a flow diagram is not meant to be limiting with respect to the order of actions performed. An overview of process (100) is provided below:

At stage (111), linguists use existing descriptions of a source language (110) to formally describe systematic lexical and syntactic differences between a target language and the source language. Based on this, a base syntactic and morphology model may be created.

At stage (112), parallel texts (108) in the source language and the target language are aligned. This may be facilitated by the use of a translation dictionary.

At stage (113), source language sentences from the parallel texts are parsed using technology for deep analysis. Language-independent descriptions and language-dependent descriptions of the source language may be used during this process to construct syntactic and semantic structures of sentences in the source language.

At stage (114), the translation dictionary may be used to make hypotheses about corresponding lexical elements in sentences of the target language and source language.

At stage (115), the lexical elements of the target language are associated with the syntactic models of the corresponding lexical elements of the source language, taking into account determined systematic transformations and the differences. Lexical elements of the target language may be replaced by the syntactic models of the corresponding elements of the source language.

At stage (116), the hypotheses may be verified based on annotated or other parallel texts. Process (100) and its various stages, including language descriptions and structural elements required to support process (100), will be described in further detail herein.

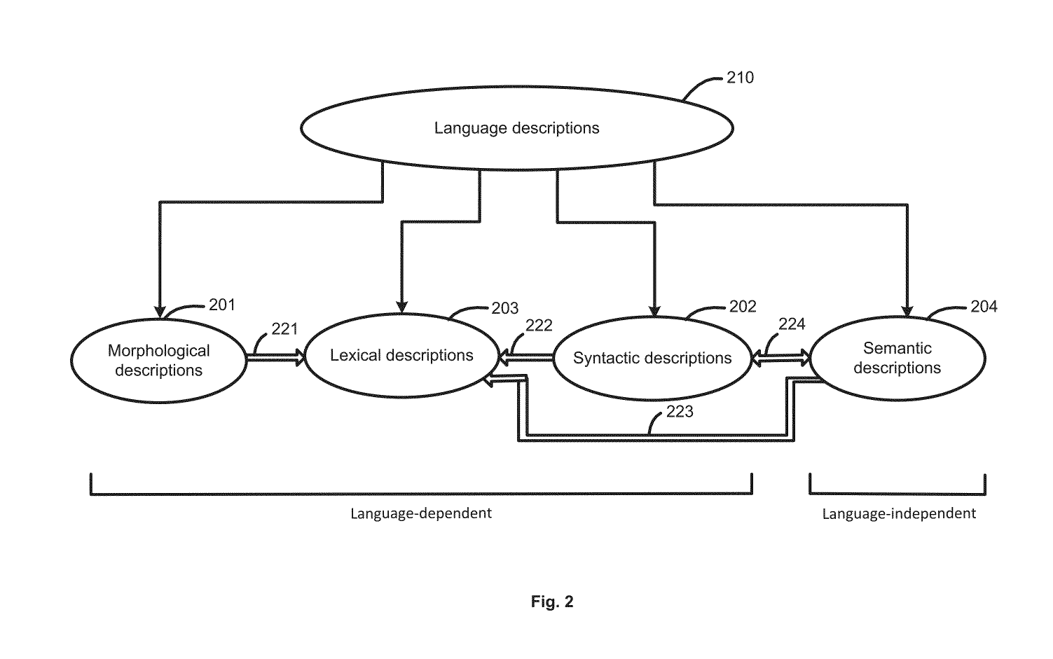

Referring to FIG. 2, a chart illustrating the necessary language descriptions (210) and relationships between the descriptions is shown according to one embodiment. Language descriptions (210) include morphological descriptions (201), syntactic descriptions (202), lexical descriptions (203), and semantic descriptions (204). Among the language descriptions (210), the morphological descriptions (201), the lexical descriptions (203), and the syntactic descriptions (202) are language-specific. Each of these language descriptions (210) can be created for each source language, and together, they represent a model of the source language. The semantic descriptions (204), however, are language-independent and are used to describe language-independent semantic features of various languages, and to construct language-independent semantic structures which represent language-independent meanings of sentences.

The morphological descriptions (201), the lexical descriptions (203), the syntactic descriptions (202), and the semantic descriptions (204) are related. Lexical descriptions (204) and morphological descriptions (201) are related by link (221), because a specified lexical meaning in the lexical description (203) may have a morphological model represented as one or more grammatical values for the specified lexical meaning. For example, one or more grammatical values can be represented by different sets of grammemes in a grammatical system of the morphological descriptions (101).

Additionally, as depicted by link (222), a given lexical meaning in the lexical descriptions (203) may also have one or more surface models corresponding to the syntactic descriptions (202) for the given lexical meaning. As represented by a link (223), the lexical descriptions (203) can also be related to the semantic descriptions (204). Therefore, the lexical descriptions (203) and the semantic descriptions (204) may be combined to form “lexical-semantic descriptions,” such as a lexical-semantic dictionary.

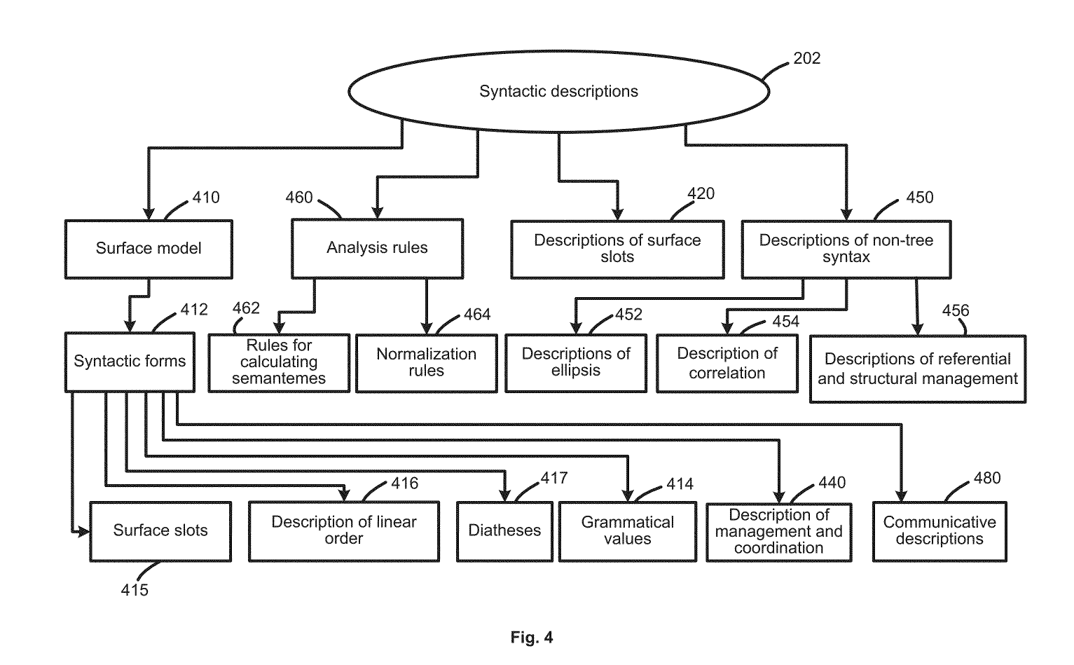

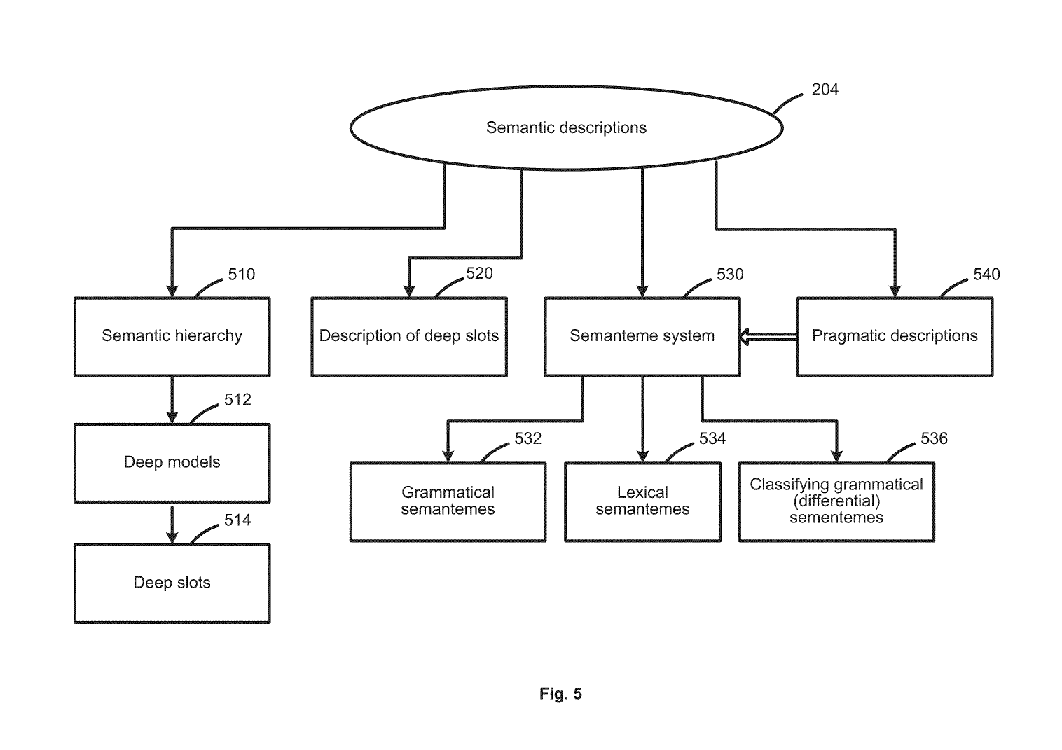

As depicted by link (224), syntactic descriptions (202) and the semantic descriptions (204) are also related. For examples, diatheses (e.g., 417 of FIG. 4), which may be part of the syntactic descriptions (202), can be considered the “interface” between the language-dependent surface models and the language-independent deep models (e.g., 512 of FIG. 5) of the semantic description (204).

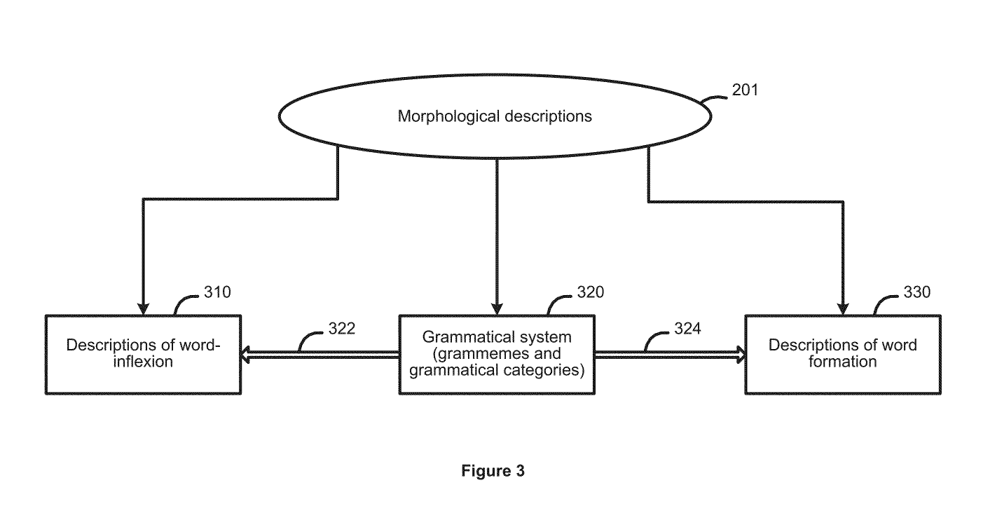

Referring to FIG. 3 a chart illustrating morphological descriptions is shown according with one embodiment. The components of the morphological descriptions (201) include, but are not limited to, word-inflexion description (310), grammatical system (320) (e.g., grammemes and grammatical categories), and word-formation descriptions (330), among others. The grammatical system (320) includes a set of grammatical categories, such as, “Part of speech,” “Case,” “Gender,” “Number,” “Person,” “Reflexivity,” “Tense,” “Aspect,” etc., and their meanings, which are referred to as “grammemes.” As an example, such grammemes may be: Adjective, Noun, Verb, etc. As another example, such grammemes may be: Nominative, Accusative, Genitive, etc. As another example, such grammemes may be: Feminine, Masculine, Neutral, etc. Other grammemes also exist and the scope of the present disclosure is not limited to particular grammemes.

A word-inflexion description (310) describes how a main word form may change according to its case, gender, number, tense, etc., and may describe all possible forms for the word. A word-formation (330) describes which new words may be generated involving the main word (for example, there are a lot of compound words in the German language). The grammemes are units of the grammatical systems (320) and, as depicted by link (222) and link (324), the grammemes may be utilized to build the word-inflexion description (310) and the word-formation descriptions (330).

According to one embodiment, when establishing syntactic relationships for elements of the source sentence, a constituent model is used. A constituent may include a contiguous group of words in a sentence that may behave as one entity. A constituent has a word at its core, and can include child constituents at lower levels. A child constituent is referred to as a dependent constituent and may be attached to other constituents (i.e., parent constituents) to build the syntactic descriptions (202) of the source sentence.

Referring to FIG. 4, a chart illustrating syntactic descriptions is shown according to one embodiment. The components of the syntactic descriptions (202) may include, but are not limited to, surface models (410), surface slot descriptions (420), non-tree syntax description (450), and analysis rules (460). The syntactic descriptions (202) are used to construct possible syntactic structures of a source sentence from a given source language, taking into account a free linear word order, non-tree syntactic phenomena (e.g., coordination, ellipsis, etc.), referential relationships, and other considerations.

The surface models (410) are represented as aggregates of one or more syntactic forms (e.g., syntforms 412) in order to describe possible syntactic structures of sentences included in the syntactic description (202). In general, the lexical meaning of a language is linked to its surface (syntactic) models (410), which represent constituents that are possible when the lexical meaning functions as a “core” and includes a set of surface slots of child elements, a description of the linear order, diatheses, etc.

The surface models (410) may be represented by syntforms (412). Each syntform (412) may include a certain lexical meaning which functions as a “core” and may further include a set of surface slots (415) of its child constituents, a linear order description (416), diatheses (417), grammatical values (414), management and coordination descriptions (440), communicative descriptions (480), among others, in relationship to the core of the constituent.

The surface slot descriptions (420), which a part of syntactic descriptions (202), are used to describe the general properties of the surface slots (415) used in the surface models (410) of various lexical meanings in the source language. The surface slots (415) may express syntactic relationships between the constituents of the sentence. Examples of the surface slot (415) may include, but are not limited to: “subject,” “object_direct,” “object_indirect,” “relative clause,” among others.

During the syntactic analysis, the constituent model utilizes a plurality of the surface slots (415) of the child constituents and their linear order descriptions (416) and describes the grammatical values (414) of the possible fillers of these surface slots (415). The diatheses (417) represent correspondences between the surface slots (415) and deep slots (e.g., 514 of FIG. 5). The diatheses (417) are related by a link (e.g., 224 of FIG. 2) between syntactic descriptions (e.g., 202 of FIG. 2) and semantic descriptions (e.g., 204 of FIG. 2). The communicative descriptions (480) describe communicative order in a sentence.

The syntactic forms, syntforms (412), include set of the surface slots (415) coupled with the linear order descriptions (416). One or more constituents for a lexical meaning of a word form of a source sentence may be represented by surface syntactic models, such as the surface models (410). These constituents may be viewed as the realization of the constituent model by selecting a corresponding syntform (412). The selected syntactic forms of syntforms (412) are sets of the surface slots (415) with a specified linear order. Every surface slot in a syntform may have grammatical and semantic restrictions on what may fill the slot.

The linear order description (416) includes linear order expressions that are formed to express a sequence in which various surface slots (415) can occur in the sentence. The linear order expressions may include names of variables, names of surface slots, parenthesis, grammemes, ratings, and the “or” operator, etc. For example, a linear order description for a simple sentence of “Boys play football” may be represented as “Subject Core Object_Direct,” where “Subject”, “Object_Direct” are names of surface slots (415) corresponding to the word order. Fillers of the surface slots (415) as indicated by symbols of entities of the sentence may be present in the same order of the entities in the linear order expressions.

Different surface slots (415) may be in a strict “and/or” relationship in the syntform (412). Also, parenthesis may be used to build the linear order expressions and describe strict linear order relationships between different surface slots (415). For example, “SurfaceSlot1 SurfaceSlot2,” or “(SurfaceSlot1 SurfaceSlot2)” means that both surface slots are located in the same linear order expression, but only the specified order of the surface slots relative to each other is possible, such that SurfaceSlot2 must follow after SurfaceSlot1.

Further, square brackets may be used to build the linear order expressions and describe variable linear order relationships between different surface slots (415) of the syntform (412). For example, [SurfaceSlot1 SurfaceSlot2] indicates that both surface slots belong to the same variable of the linear order and their order relative to each other is irrelevant.

The linear order expressions of the linear order description (416) may contain grammatical values (414), expressed by grammemes, to which child constituents correspond. In addition, two linear order expressions can be joined by the operator | ( [symbol] OR [symbol] ). For example: (Subject Core Object) | [Subject Core Object].

The communicative descriptions (480) describe a word order in the syntform (412) from the point of view of communicative acts to be represented as communicative order expressions, which are similar to linear order expressions. The management and coordination description (440) contains rules and restrictions on grammatical values of attached constituents that are used during syntactic analysis.

The non-tree syntax descriptions (450) are related to processing various linguistic phenomena, such as, ellipsis and coordination, and are used in syntactic structure transformations that are generated during various steps of analysis according to the embodiments disclosed herein. The non-tree syntax descriptions (450) may include ellipsis descriptions (452), correlation descriptions (454), and referential and structural management descriptions (456), among others.

The analysis rules (460), which are part of the syntactic descriptions (202), may include semantemes calculation rules (462) and normalization rules (464). Although analysis rules (460) are used during semantic analysis, the analysis rules (460) generally describe properties of a specific language and are related to the syntactic descriptions (e.g., 202 of FIG. 2). The normalization rules (464) are generally used as transformational rules to describe transformations of semantic structures which may be different in various languages.

Referring to FIG. 5, a chart illustrating semantic descriptions is shown according to one embodiment. The components of the semantic descriptions (e.g., 204) are language-independent, and may include a semantic hierarchy (510), deep slots descriptions (520), a system of semantemes (530), and pragmatic descriptions (540).

The semantic hierarchy (510) comprises semantic notions (semantic entities) named semantic classes which are arranged into hierarchical parent-child relationships similar to a tree. In general, a child semantic class may inherit some or all properties of its direct parent and all ancestral semantic classes of higher levels. For example, the semantic class SUBSTANCE is a child of semantic class ENTITY, and the parent of semantic classes GAS, LIQUID, METAL, WOOD_MATERIAL, etc.

Each semantic class in the semantic hierarchy (510) is supplied with a deep model (512). The deep model (512) of the semantic class includes a set of the deep slots (514), which reflect the semantic roles of child constituents in various sentences, with objects of the semantic class as the core of a parent constituent, and possible semantic classes as fillers of deep slots. The deep slots (514) express semantic relationships, including, for example, “agent,” “addressee,” “instrument,” “quantity,” etc. A child semantic class may inherit and adjust the deep model (512) of its direct parent semantic class

The deep slots descriptions (520) describe the general properties of the deep slots (514) and reflect the semantic roles of child constituents in the deep models (512). The deep slots descriptions (520) also contain grammatical and semantic requirements for the fillers of the deep slots (514). The properties and restrictions for the deep slots (514) and their possible fillers are typically very similar and often times identical among different languages. Accordingly, the deep slots (514) are language-independent.

The system of semantemes (530) includes a set of semantic categories and semantemes, which represent the meanings of the semantic categories. As an example, a semantic category “DegreeOfComparison” can be used to describe the degree of comparison its semantemes may be, such as: “Positive,” “ComparativeHigherDegree,” “SuperlativeHighestDegree,” etc. As another example, a semantic category “RelationToReferencePoint” can be used to describe the order (e.g., before or after a reference point) its semantemes may be, such as: “Previous” or “Subsequent.” The order may also be described spatially or temporally in a broad sense of the words being analyzed. As another example, a semantic category “EvaluationObjective” can be used to describe an objective assessment, such as: “Bad” or “Good,” etc.

The systems of semantemes (530) include language-independent semantic attributes which not only express semantic characteristics, but also express stylistic, pragmatic, and communicative characteristics. Some semantemes can be used to express an atomic meaning, which finds a regular grammatical and/or lexical expression in a language. The system of semantemes (530) may be divided into various categories according to their purpose and usage. For example, these categories may include grammatical semantemes (532), lexical semantemes (534), and classifying grammatical (differentiating) semantemes (536).

The grammatical semantemes (532) are used to describe grammatical properties of constituents when transforming a syntactic tree into a semantic structure. The lexical semantemes (534) describe specific properties of objects (for example, an object “being flat” or “being liquid,” etc.) and are used in the deep slot descriptions (520) as restrictions for deep slot fillers. The classifying grammatical (differentiating) semantemes (536) express the differentiating properties of objects within a single semantic class. For example, in the semantic class HAIRDRESSER, the semanteme <<RelatedToMen>> may be assigned to the lexical meaning “barber,” as opposed other lexical meanings which also belong to the class, such as “hairdresser” or “hairstylist,” etc.

A pragmatic description (540) allows the system to assign a corresponding theme, style, or genre to texts and objects of the semantic hierarchy (510). For example, such pragmatic descriptions may include “Economic Policy,” “Foreign Policy,” “Justice,” “Legislation,” “Trade,” “Finance,” etc. Pragmatic descriptions can also be expressed by semantemes. Also, a pragmatic context may be taken into consideration during the semantic analysis.

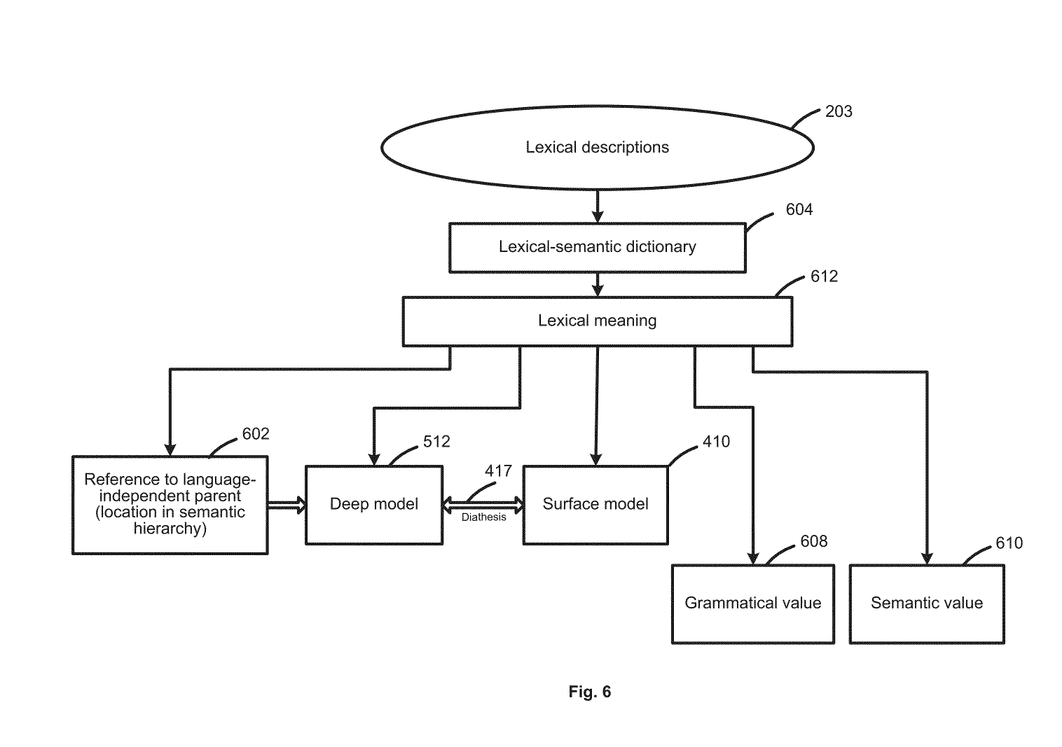

Referring to FIG. 6, a chart illustrating lexical descriptions is shown according to one embodiment. The lexical descriptions (203) may include a lexical-semantic dictionary (604), which includes a plurality of lexical meanings (i.e. values) (612) in a specific language for each component of a sentence. For each lexical meaning (612), a reference (602) to its language-independent semantic parent may be established to indicate the location of a given lexical meaning in the semantic hierarchy (510).

Each lexical meaning (612) is connected with a deep model (512), which is described in language-independent terms, and a surface model (410), which is language-specific. Diatheses (417) can be used as the “interface” between the surface models (410) and the deep models (512) for each lexical meaning (612). One or more diatheses (417) can be assigned to each surface slot (e.g., 415) in each syntform (e.g., 412) of the surface models (410).

While the surface model (410) describes the syntactic roles of surface slot fillers, the deep model (512) generally describes the semantic roles of the surface slot fillers. A deep slot description (520) expresses the semantic type of a potential slot-filler, and reflects the real-world aspects of situations, properties, or attributes of the objects denoted by words of any natural language. Each deep slot description (520) is language-independent since different languages may use the same deep slot to describe similar semantic relationships or express similar aspects of the situations. The fillers of the deep slots (514) also generally have the same semantic properties even in different languages. Each lexical meaning (612) of a lexical description of a language may inherit a semantic class from its parent and adjust the parent's deep model (512).

The generation of lexical meaning descriptions and corresponding models is the most labor-intensive part of filling in the semantic hierarchy for a specific language. The embodiment disclosed herein allow for partial or full automation of this process. In the majority of cases, it is possible to transfer lexical models from a source language to the corresponding lexical meanings in the target language with minor corrections/revisions if the source and target languages are similar to a certain degree.

In addition, the lexical meanings (612) may contain their own characteristics and also inherit other characteristics from language-independent parent semantic class as well. These characteristics of the lexical meanings (612) include grammatical values (608), which can be expressed as grammemes, and semantic value (610), which can be expressed as semantemes.

Each surface model (410) of a lexical meaning may include one or more syntforms (412). Each syntform of a surface model (410) may include one or more surface slots (415), and may have their linear order description (416) and one or more grammatical values (414) expressed as a set of grammatical characteristics (grammemes), one or more semantic restrictions on surface slot fillers, and one or more of diatheses (417). Semantic restrictions of a surface slot filler include a set of semantic classes whose objects can fill the surface slot. The diatheses are the part of relationship (224) between syntactic descriptions (202) and semantic descriptions (204), and the diatheses represent correspondences between the surface slots and the deep slots of the deep model (512).

With the above disclosure, and returning to FIG. 1, the process (100) for automatic creation of a universal semantic description for the target language based on a semantic hierarchy for the source language and a set of parallel texts is described in detail.

In stage (111), linguists formally describe systematic lexical and syntactic differences between the target language and the source language. The linguists also create a target language syntax model and a target language morphology model (e.g., dictionary). The target language syntax model and a target language morphology model may be separate models, or part of a single model. As an example, process 100 can be applied to a pair of related languages with the same alphabet or alphabets, which have substantial overlap/similarity. A lexical similarity may be due to similar word formation mechanisms. Such pairs of languages exist and generally belong to the same language group. For example, pairs of languages may include: Russian—Ukrainian, Russian—Belorussian, Latvian—Lithuanian, Russian—Polish, Russian—Bulgarian, Ukrainian—Belorussian, Ukrainian—Polish, Ukrainian—Slovak, and German—Dutch, etc.

Stage (111) may be omitted from process (100). However, the descriptions generated during stage (111) may increase the accuracy of results obtains from process (100). In one embodiment, the linguist can describe a morphological model for the target language that includes word change paradigms, a grammatical category system, and a morphological dictionary. The morphological dictionary may also be produced in various ways. For example, the “Method and system for natural language dictionary generation,” as described in U.S. patent application Ser. No. 11/769,478, may be used for automatic construction of a morphological dictionary based on a text corpus. In another embodiment, the morphological description of the target language may not be present initially, but is later created as a result of using process 100 over the morphological dictionary of the source language after the correspondences between the source language and the target language words are established. In this situation, if there is enough volume of text in the target language, the benefit of performing an additional verification of the hypotheses about the morphology model for each word in the text corpora may be taken advantage of, such as is done in the method described in U.S. Patent Application No. 11/769,478.

As an example, systematic differences between the source language and the target language might be as follows: a system of cases might differ, a verb tense system might differ, and a set of genders or number of nouns or pronouns might differ. Other differences may also exist. As another example, a pronoun in one language may be governed by one case, while the corresponding pronoun in the other language is governed by another case. Word formation mechanisms may also differ, such as in the formation of complex words, etc. All of these differences may be formally described as transformation rules. Transformation rules may also be described programmatically (e.g., in program scripts or procedures, etc.).

Differential descriptions of the target language may refer to the descriptions of the surface slots (420). For example, a surface slot in the target language may be used with a different pronoun or may require a different case. Differential descriptions may be about diatheses (417); for example, there may be different semantic limitations in the target language. In a different manner, linear sequence (416) may be described in the target language. Also, a non-tree syntax (450) may contain various differences. Generally speaking, any element of syntactic descriptions shown in FIG. 4 may differ in nomenclature, but these distinctions can be systematically found and described.

The essence of this disclosure is that after lexical elements of the source language and the target language have been correlated, the lexical descriptions (203) and the syntactic description (202) (see FIG. 4) of the source language are corrected and inserted into the target language, and a syntactic model of the target language is thus obtained semi automatically, including surface models (410) of the lexical elements and using surface slot descriptions (420), a referential and structural control description (430), a government and agreement description (440), a non-tree syntax description (450), and the analysis rules (460) of the source language and the systematic differences described.

The next stage of process (112) is completed by using a sufficiently large corpus of parallel texts. Texts in two languages in which the text in one (the first) language corresponds to the text in the other (the second) language are referred to as parallel texts; in the general case, this may be a translation into the second language. In this case, texts are needed that contain the specific source language and the specific target language. These parallel texts may be obtained in any manner. For best results, the parallel texts must be of good quality. At stage (112), the parallel texts are aligned (i.e., they are put into a condition in which each sentence in the first language is correlated to a sentence in the second language, and vice versa). Specially designed programs may be used to do so, including programs that use a translation dictionary. A translation dictionary may be produced from any electronic dictionary or may be created from a paper dictionary using optical recognition and software processing. A requirement for an alignment program is that it must be able to indicate what word in the source language is translated by what word in the target language.

A potential method for aligning parallel texts is set forth in U.S. patent application Ser. No. 13/464,447. Stage 112 may be skipped if the existing parallel texts are already aligned.

Stage (113) consist of parsing every sentence in the source language in accordance with the technology for deep semantic-syntactic analysis, which is described in detail in U.S. Pat. No. 8,078,450, entitled “Method and system for analyzing various languages and constructing language-independent semantic structures.” This technology uses all the language descriptions (210) described, including morphological descriptions (201), lexical descriptions (203), syntactic descriptions (202), and semantic descriptions (204).

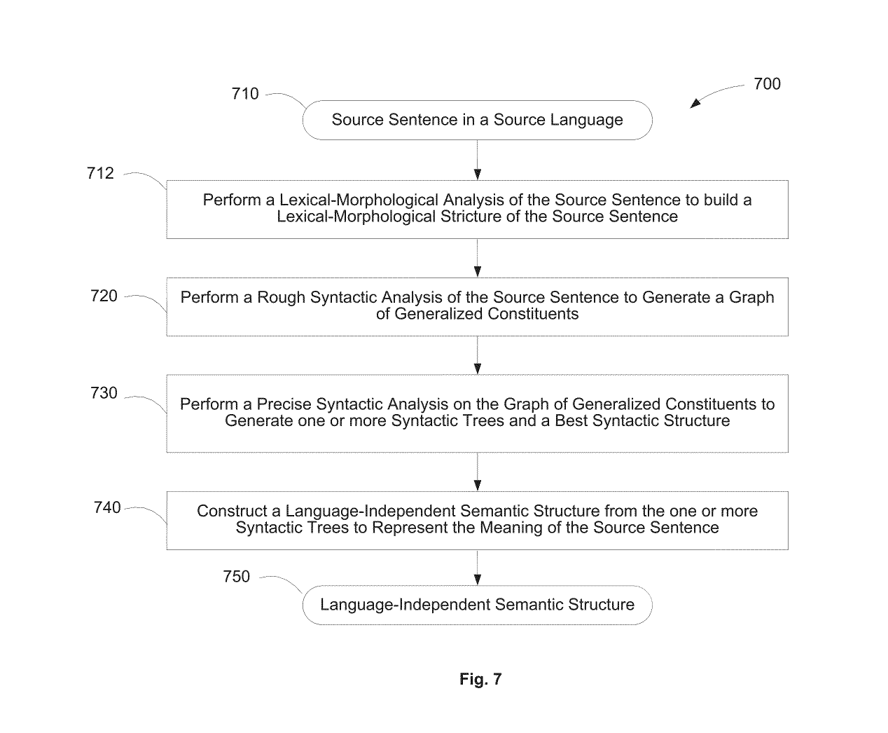

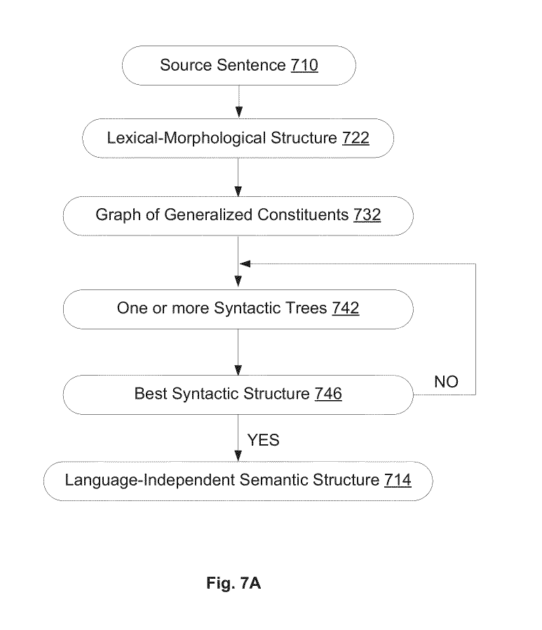

Referring to FIGS. 7 and 7A, the main stages of the semantic-syntactic analysis method 700 are shown, and a sequence of data structures built from the process of analyzing is shown, respectively.

At stage (712), a source sentence (710) is subjected to lexical-morphological analysis to build a lexical-morphological structure of the source sentence. The lexical-morphological structure (722) includes a set of all possible pairs of “lexical meaning—grammatical meaning” for each lexical element (i.e., word) in the sentence.

A rough syntactic analysis is performed on the source sentence (720) to generate a graph of generalized constituents (732). During the rough syntactic analysis (720), for each lexical element of the lexical-morphological structure (722), all the possible syntactic models for the lexical element are applied and checked to find all the potential syntactic links in the sentence, which is expressed in the graph of generalized constituents (732).

The graph of generalized constituents (732) may be an acyclic graph in which the nodes are generalized lexical meanings (they may store variants) for words in the sentence, and the branches are surface (syntactic) slots, which express various types of relationships between the combined lexical meanings. All possible surface syntactic models are used for each element of the lexical-morphological structure of the sentence as a potential core for the constituents. Then, all possible constituents are prepared and generalized into a graph of generalized constituents (732). As a result, all of the possible syntactic models and syntactic structures for the source sentence (710) are examined and a graph of generalized constituents (732) based on a set of generalized constituents is constructed as a result. The graph of generalized constituents (732) at the surface model level reflects all the potential links between words of the source sentence (713). Because the number of variants of a syntactic parsing can be large, the graph of generalized constituents (732) is large and may have a great number of variations—both in selecting a lexical meaning from a set for each node and in selecting the surface slots for the graph branches.

For each “lexical meaning—grammatical value” pair, the surface model is initialized, and other constituents are added in the surface slots (415) of the syntform (syntactic form) (412) of its surface model (410) and in the neighboring constituents on the left and on the right. These syntactic descriptions are depicted in FIG. 4. If an appropriate syntactic form is found in the surface model (410) for the corresponding lexical meaning, then the selected lexical meaning may serve as the core for a new constituent (or constituents).

The graph of generalized constituents (732) is initially constructed as a tree, starting from the leaves and continuing to the root (i.e., bottom to top). Additional constituents may be constructed from bottom to top by adding child constituents to parent constituents by filling surface slots (415) of the parent constituents in order to cover all the initial lexical units of the source sentence (710). The root of the tree, which is the main node of graph (732), generally constitutes the predicate. During this process, the tree typically transforms into a graph, as the lower-level constituents (leaves) may be attached to several higher-level constituents (root). Several constituents that are constructed for the same constituent of the lexical-morphological structure may later be generalized to produce one generalized constituent. Constituents may be generalized based on lexical meanings (612) or grammatical values (414), such as those based on parts of speech and the relationships between them.

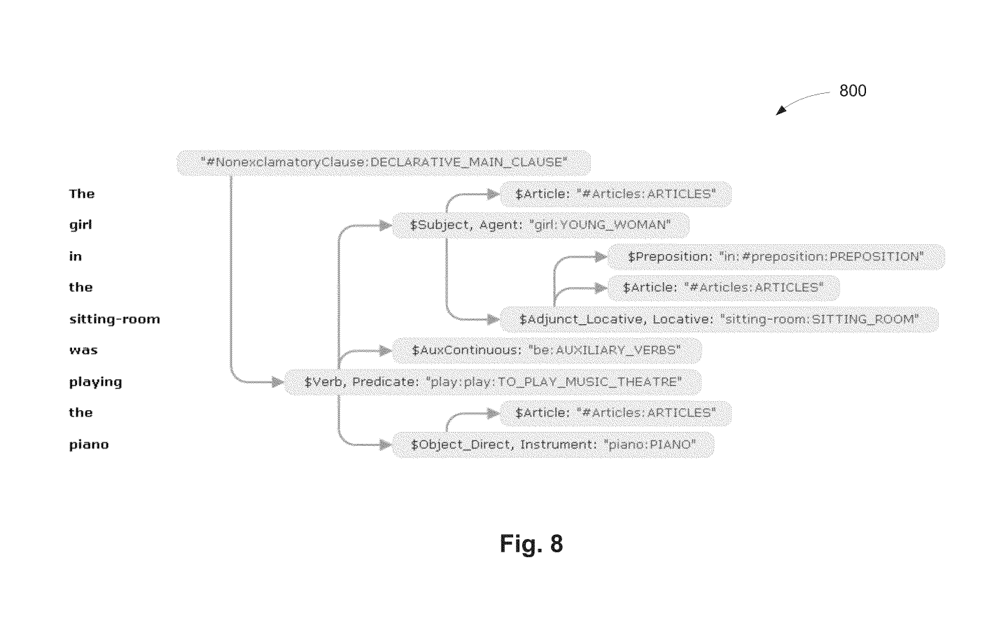

Precise syntactic analysis (730) is done to generate one or more syntactic trees (742) from the graph of generalized constituents (732). One or more syntactic trees for the sentence may be constructed, and a total rating for each tree is computed based on the use of a set of a priori and computed ratings. The tree with the best rating is then selected to construct the best syntactic structure (746) for the source sentence. FIGS. 8 and 8A show two different possible syntactic trees (800) and (800A), respectively, for the English sentence “The girl in the sitting-room was playing the piano.”

The syntactic trees are generated as a process of advancing and checking hypotheses about a possible syntactic structure for a sentence, and hypotheses about the structure of parts of the sentence are generated as part of a hypothesis about the structure of the entire sentence.

During the process of forming the syntactic structure (746) from the selected syntactic tree, non-tree links are established. However, if non-tree links could not be set, then the syntactic tree having the next highest rating is selected, and an attempt is made to set up non-tree links on the next highest rated tree. As a result of the precise analysis (730), a best possible syntactic structure (746) for the sentence is analyzed.

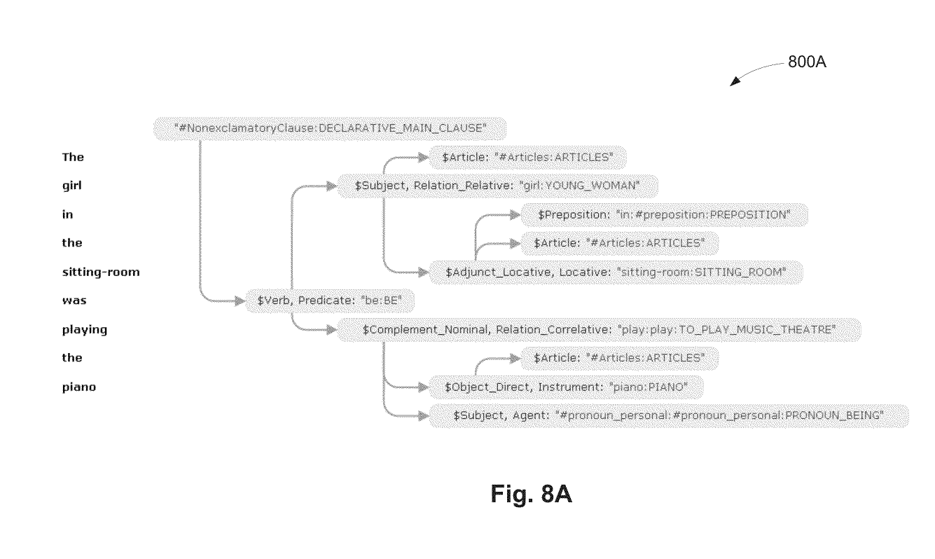

At stage (740), a language-independent semantic structure is constructed and there is a transition to a language-independent semantic structure (750), which reflects the sense of the sentence in universal language-independent concepts. The language-independent semantic structure of the sentence is represented as an acyclic graph (a tree, supplemented by non-tree links) where each word of a specific language is replaced with universal (language-independent) semantic entities, referred to as called semantic classes herein. The transition is facilitated using semantic descriptions (204) and analysis rules (460), which results in a graph structure having a main node. In this graph, the nodes are represented by semantic classes that are supplied with a set of attributes semantemes (e.g., the attributes express the lexical, syntactic, and semantic properties of specific words of the source sentence), and the branches represent the deep (semantic) relationships between the words (nodes) that they join. Referring to FIG. 9, the semantic structure (900) for the English sentence “The girl in the sitting-room was playing the piano” is shown, according to one embodiment.

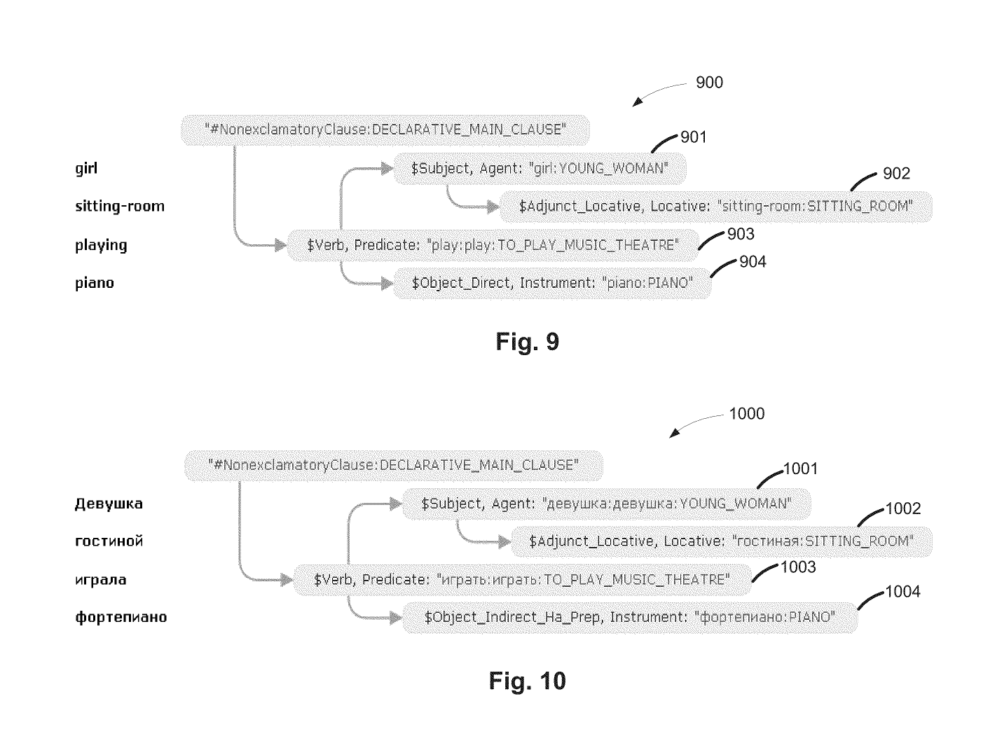

It is important that if there are two sentences (a first in the source language and a second in the target language, where the second sentence is a precise translation of the first sentence into the target language and vice versa) that their semantic structures in the general case can be considered to accurately match their semantic classes. Referring to FIG. 10, the semantic structure (1000) is shown according to one embodiment. Semantic structure (1000) corresponds to the Russian sentence “ [symbol] [symbol] [symbol] [symbol] ,” which corresponds to the English sentence shown in FIG. 9. The semantic structures (900) and (1000) in FIGS. 9 and 10, respectively, have the same configurations and the same semantic classes at the nodes of the structures: YOUNG_WOMAN (901) and (1001), SITTING_ROOM (902) and (1002), TO_PLAY_MUSIC_THEATRE (903) and (1003), and PIANO (904) and (1004).

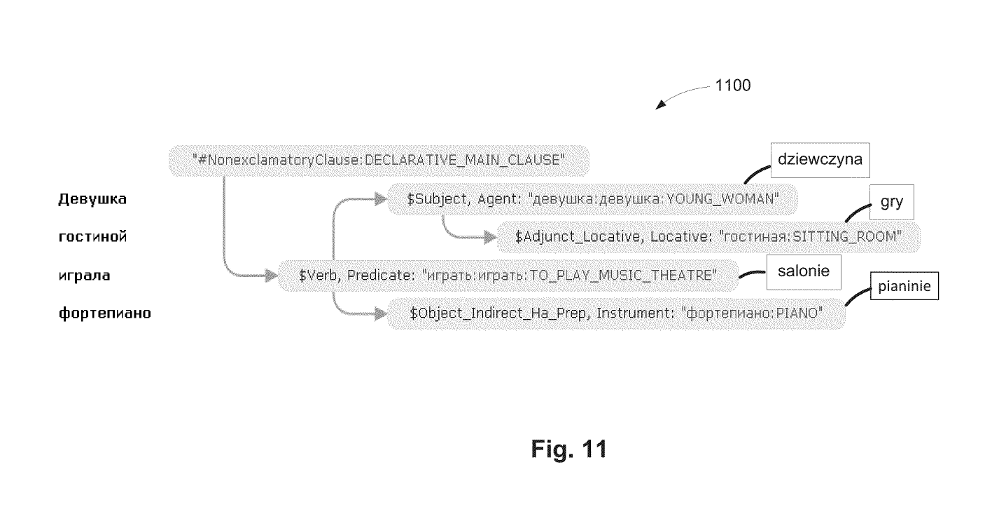

Returning to FIG. 1 at stage (114), a translation dictionary is used to form hypotheses about corresponding lexical elements in both sentences. Referring to FIG. 11, according to one embodiment, the result (i.e. semantic structure (1100)) of constructing the semantic description of the target (Polish) language based on the semantic description of the source (Russian) language is shown. FIG. 11 depicts the example of parsing the Russian sentence “ [symbol] [symbol] [symbol] [symbol] ” and its Polish equivalent, “Dziewczyna w salonie gry na pianinie.” By using the translation dictionary or information from the alignment obtained at stage (112), correspondence between the following lexical elements can be established: “ [symbol] —dziewczyna,” “ [symbol] —salonie,” “ [symbol] —gry,” and “ [symbol] —pianinie.”

Thus, FIG. 11 illustrates filling in a semantic hierarchy in a language-dependent portion of the target language. In this example, after the correspondence between the lexical elements of the two languages is established, hypotheses are generated under which lexical meanings of the Polish language can be added to the corresponding semantic classes of the semantic hierarchy: “dziewczyna:YOUNG_WOMAN,” “salonie:SITTING_ROOM,” “grać: TO_PLAY_MUSIC_THEATRE” (grać is the base form for the verb gry), and “pianinie: PIANO.” A decision about accepting structure (1100) may be made after the lexical elements of the target language syntactic models are compared to the elements in the source language in stage (115) and the hypotheses are checked in stage (116).

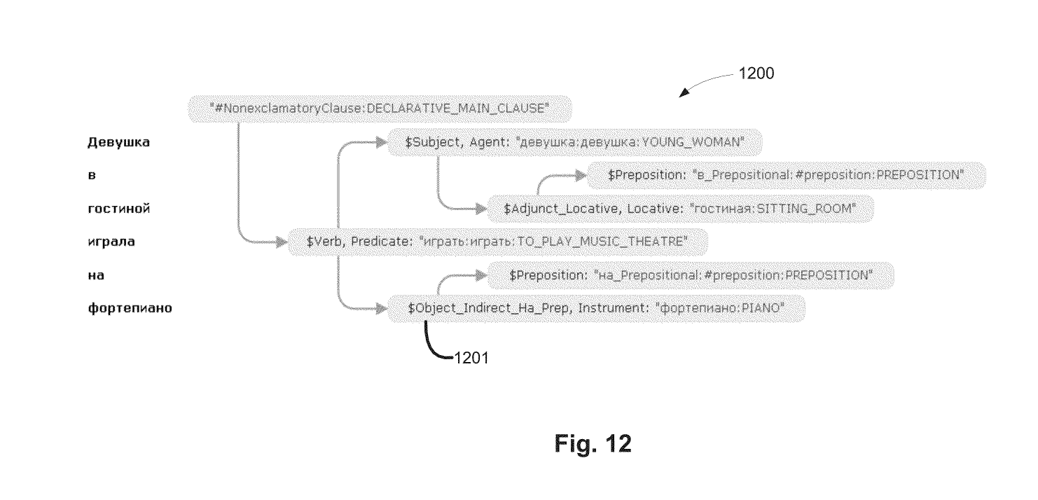

Prefixes, articles, participles, and other ancillary parts of speech may not be reflected in semantic structures. Articles and participles may be coded using grammatical semantemes, and prefixes may be characterized by the corresponding surface slots. The number of prefixes in any language is generally not very large and a prefix in one language can transition to the prefix it corresponds to in the other language, and that this may happen in different ways in different surface slots is described in stage (111). For example, in the systematic syntactic differences descriptions, a description is included for under what circumstances the preposition “B” in the Russian surface slot $Adjunct_Locative maps to the preposition “w” in Polish, and in which circumstances that it maps to a different preposition. Referring to FIG. 12, a syntactic structure (1200) is shown for the Russian sentence “ [symbol] [symbol] [symbol] [symbol] ,” according to one embodiment. In the descriptions of the systematic syntactic differences, the Polish surface slot to which the Russian surface slot $Object_Indirect_Ha_Prep (1201) transitions is also shown. For example, perhaps the surface slot $Object_Indirect_Na_Prep should be introduced, and how this position differs from $Object_Indirect_Ha_Prep is also depicted.

At stage (115), the added lexical elements of the target language syntactic models are associated with the corresponding elements of the source language. The syntactic models for the lexical elements are taken from the corresponding elements of the source language, taking into account the systematic transformations described. For example, with the lexical meaning “grać: TO_PLAY_MUSIC_THEATRE”, a syntactic model corresponding to the Russian verb “ [symbol] : TO_PLAY_MUSIC_THEATRE ” may be accepted and adapted. The presence of all (or a majority) of the syntforms possible for the lexical meaning may be checked in the corpus of annotated texts or in other parallel text corpora. At stage (115), a list of checkable syntforms is also compiled for each added lexical meaning. In other words, a list is compiled of possible contexts in the target language in which the lexical meaning may be found.

At stage (115), the hypotheses are checked using annotated or other parallel texts in the target language. An annotated text may be a text in which each word is annotated (supplied) with a part of speech. For example, there may be an index for each text. A check may be performed using N-grams, where N=2, 3, . . . . The hypothesis testing may consist of seeking all possible contexts from the list of possible contexts. The context may be coded with metatools using generalized concepts, such as part of speech, semantic class, etc. The contexts, which may be found to be confirmed in the existing corpora, supplement the lexical model for this lexical meaning. As the semantic hierarchy is filled in, it is possible to do further learning using the lexical meanings of the target language already recorded and using models checked using text corpora. As the annotated corpora grow, the lexical model is supplemented with those syntforms that were found in the new corpora.

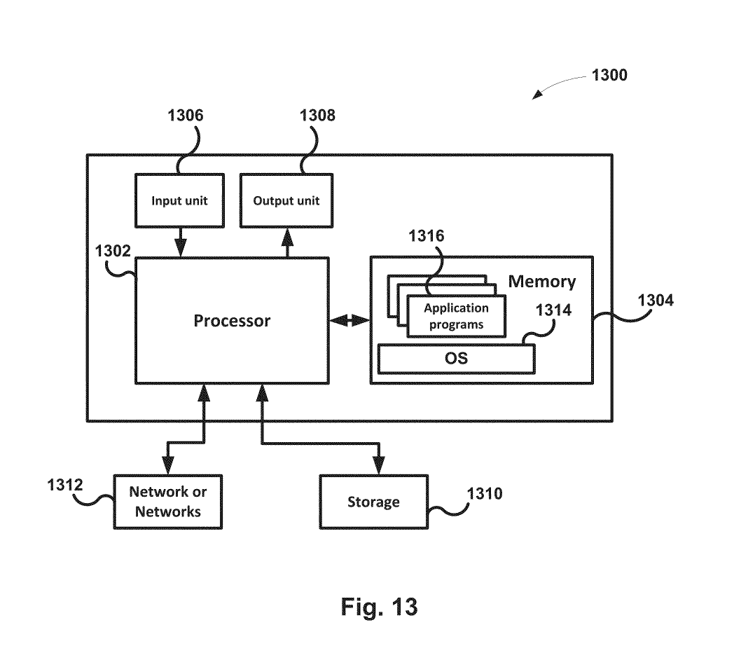

Referring to FIG. 13, a possible example of a computer platform (1300) that may be used to implement the techniques of this disclosure is shown, according to one embodiment. The computer platform (1300) includes at least one processor (1302) connected to a memory (1304). The processor (1302) may be one or more processors and may contain one, two or more computer cores. The processor (1302) may be any commercially available CPU and may be implemented as a general-purpose processor, an application specific integrated circuit (ASIC), one or more field programmable gate arrays (FPGAs), a digital-signal-processor (DSP), a group of processing components, or other suitable electronic processing components. The memory (1304) may include random access memory (RAM) devices comprising a main storage of the platform (1300), as well as any supplemental levels of memory, e.g., cache memories, non-volatile or back-up memories (e.g., programmable or flash memories), read-only memories, etc. In addition, the memory (1304) may include memory storage physically located elsewhere in the platform (1300), e.g., any cache memory in the processor (1302) as well as any storage capacity used as a virtual memory, e.g., as stored on a mass storage device (1310). The memory (1304) may store (alone or in conjunction with mass storage device (1310)) database components, object code components, script components, or any other type of information structure for supporting the various activities and information structures described herein. The memory (1304) or mass storage device (1310) may provide computer code or instructions to the processor (1302) for executing the processes described herein.

The computer platform (1300) also usually has a certain number of input and output ports to transfer information out and receive information. For interaction with a user, the computer platform (1300) may contain one or more input devices (such as a keyboard, a mouse, a scanner, and so forth) and a display device (1308) (such as a liquid crystal display). The computer platform (1300) may also have one or more storage devices (1310), such as e.g., floppy or other removable disk drive, a hard disk drive, a Direct Access Storage Device (DASD), an optical drive (e.g., a Compact Disk (CD) drive, a Digital Versatile Disk (DVD) drive, etc.) and/or a tape drive, among others. Furthermore, the computer platform (1300) may include an interface with one or more networks (1312) (e.g., a local area network (LAN), a wide area network (WAN), a wireless network, and/or the Internet among others) to permit the communication of information with other computers coupled to the networks. It should be appreciated that the computer platform (1300) typically includes suitable analog and/or digital interfaces between the processor 502 and each of the components (1304), (1306), (1308), and (1312), as is well known in the art.

The computer platform (1300) may operate under the control of an operating system (1314), and may execute various computer software applications (1316), comprising components, programs, objects, modules, etc. to implement the processes described above. In particular, the computer software applications may include a parallel text alignment application, a semantic-syntactic analysis application, an optical character recognition application, a dictionary application, and also other installed applications for the automatic creation of a semantic description of a target language. Any of the applications discussed above may be part of a single application, or may be separate applications or plugins, etc. Applications (1316) may also be executed on one or more processors in another computer coupled to the platform (1300) via a network (1312), e.g., in a distributed computing environment, whereby the processing required to implement the functions of a computer program may be allocated to multiple computers over a network.

In general, the routines executed to implement the embodiments may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements of disclosed embodiments. Moreover, various embodiments have been described in the context of fully functioning computers and computer systems, those skilled in the art will appreciate that the various embodiments are capable of being distributed as a program product in a variety of forms, and that this applies equally regardless of the particular type of computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD-ROMs), Digital Versatile Disks (DVDs), flash memory, etc.), among others. The various embodiments are also capable of being distributed as Internet or network downloadable program products.

In the above description numerous specific details are set forth for purposes of explanation. It will be apparent, however, to one skilled in the art that these specific details are merely examples. In other instances, structures and devices are shown only in block diagram form in order to avoid obscuring the teachings.

Reference in this specification to “one embodiment” or “an embodiment” means that a particular feature, structure, or characteristic described in connection with the embodiment is included in at least one embodiment. The appearance of the phrase “in one embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

While certain exemplary embodiments have been described and shown in the accompanying drawings, it is to be understood that such embodiments are merely illustrative and not restrictive of the disclosed embodiments and that these embodiments are not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principals of the present disclosure.

What is claimed is:

1. A method of creating a semantic description of a target language, comprising:
aligning, using a processing device, parallel text of a source language and a target language such that text in the source language is correlated to text in the target language;
parsing the text in the source language to construct a syntactic structure and a semantic structure of a sentence in the source language, wherein the syntactic structure comprises a lexical element of the source language, and wherein the semantic structure comprises a language-independent representation of the sentence in the source language;
using a translation dictionary to generate a hypothesis about a lexical element of the target language that corresponds to the lexical element of the source language;
comparing the lexical element of the target language to the corresponding lexical element of the source language, wherein the comparison is based on the hypothesis; and
associating, based on the comparison, a syntactic model for the lexical element of the target language with a syntactic model for the lexical element of the source language.

2. The method of claim 1, further comprising formally describing lexical and syntactic differences between the target language and the source language to create the syntactic model for the lexical element of the target language and the syntactic model for the lexical element of the source language.

3. The method of claim 1, wherein the parallel text is based on a translation of the text of the source language into the text of the target language as defined by the translation dictionary.

4. The method of claim 1, wherein parsing the text in the source language comprises rough and precise syntactic analysis and creating a semantic structure of each sentence of the text in the source language using language-dependent descriptions and language-independent descriptions.

5. The method of claim 4, wherein the language-dependent descriptions comprise morphological descriptions, lexical descriptions, and the syntactic descriptions, and wherein the language-independent descriptions comprise semantic descriptions.

6. The method of claim 1, further comprising verifying the hypothesis based on an annotated text or a second parallel text.

7. The method of claim 1, further comprising selecting a best syntactic tree of a plurality of syntactic trees corresponding to the sentence in the source language, and wherein the syntactic and semantic structure of the sentence in the source language is based on the selected best syntactic tree.

8. A system for creating a semantic description of a target language, comprising:
a processing device configured to:
align parallel text of a source language and a target language such that text in the source language is correlated to text in the target language;
parse the text in the source language to construct a syntactic structure and a semantic structure of a sentence in the source language, wherein the syntactic structure comprises a lexical element of the source language, and wherein the semantic structure comprises a language-independent representation of the sentence in the source language;
generate, based on a translation dictionary, a hypothesis about a lexical element of the target language that corresponds to the lexical element of the source language;
compare the lexical element of the target language to the corresponding lexical element of the source language, wherein the comparison is based on the hypothesis; and
associate, based on the comparison, a syntactic model for the lexical element of the target language with a syntactic model for the lexical element of the source language.

9. The system of claim 8, wherein the syntactic model for the lexical element of the target language and the syntactic model for the lexical element of the source language are based on formally described lexical and syntactic differences between the target language and the source language.

10. The system of claim 8, wherein the parallel text is based on a translation of the text of the source language into the text of the target language as defined by the translation dictionary.

11. The system of claim 8, wherein to parse the text in the source language the processing device is configured to perform rough and precise syntactic analysis and create a semantic structure of each sentence of the text in the source language using language-dependent descriptions and language-independent descriptions.

12. The system of claim 11, wherein the language-dependent descriptions comprise morphological descriptions, lexical descriptions, and the syntactic descriptions, and wherein the language-independent descriptions comprise semantic descriptions.

13. The system of claim 8, wherein the processing device is further configured to verify the hypothesis based on an annotated text or a second parallel text.

14. The system of claim 8, wherein the processing device is further configured to select a best syntactic tree of a plurality of syntactic trees corresponding to the sentence in the source language, and wherein the syntactic and semantic structure of the sentence in the source language is based on the selected best syntactic tree.

15. A non-transitory computer-readable medium having instructions stored thereon for creating a semantic description of a target language, the instructions comprising:
instructions to align parallel text of a source language and a target language such that text in the source language is correlated to text in the target language;
instructions to parse the text in the source language to construct a syntactic structure and a semantic structure of a sentence in the source language, wherein the syntactic structure comprises a lexical element of the source language, and wherein the semantic structure comprises a language-independent representation of the sentence in the source language;
instructions to generate, based on a translation dictionary, a hypothesis about a lexical element of the target language that corresponds to the lexical element of the source language;
instructions to compare the lexical element of the target language to the corresponding lexical element of the source language, wherein the comparison is based on the hypothesis; and
instructions to associate, based on the comparison, a syntactic model for the lexical element of the target language with a syntactic model for the lexical element of the source language.

16. The non-transitory computer-readable medium of claim 15, wherein the syntactic model for the lexical element of the target language and the syntactic model for the lexical element of the source language are based on formally described lexical and syntactic differences between the target language and the source language.

17. The non-transitory computer-readable medium of claim 15, wherein the parallel text is based on a translation of the text of the source language into the text of the target language as defined by the translation dictionary.

18. The non-transitory computer-readable medium of claim 15, wherein parsing the text in the source language comprises rough and precise syntactic analysis and creating a semantic structure of each sentence of the text in the source language using language-dependent descriptions and language-independent descriptions.

19. The non-transitory computer-readable medium of claim 18, wherein the language-dependent descriptions comprise morphological descriptions, lexical descriptions, and the syntactic descriptions, and wherein the language-independent descriptions comprise semantic descriptions.

20. The non-transitory computer-readable medium of claim 15, further comprising instructions to verify the hypothesis based on an annotated text or a second parallel text.
